(19) United States
(12) Patent Application Publication
(10) Pub. No.: US 2006/0216959 A1
(43) Pub. Date: Sep. 28, 2006

(54) Clippable elastic contact element

(75) Inventors: Alexander Gelman, Fellbach (DE); David Silva, Nurtingen (DE); Ortwin Zoller, Altdorf (DE)

Correspondence Address: THE FIRM OF KARL F ROSS, 5676 RIVERDALE AVENUE, PO BOX 900, RIVERDALE (BRONX), NY, 10471-0900, US

(73) Assignee: Hirschmann Electronics GmbH & Co., KG

(21) Appl. No.: 11/441,844

(22) Filed: May 26, 2006

Related U.S. Application Data
(62) Division of application No. 10/916,764, filed on Aug. 11, 2004.

(30) Foreign Application Priority Data
Aug. 11, 2003 (DE) 10336846.9
Dec. 12, 2003 (DE) 10358120.0

(51) Int. Cl. H01R 12/00

(52) U.S. Cl. 439/66

(57) ABSTRACT

A housing holds a first contact partner adjacent a throughgoing hole in the housing. Electrical contact is made between this first contact partner and a second contact partner outside the housing by a device having an electrically conductive and elastically deformable contact element engaged with all-around play in the hole between the contact partners and bearing elastically in one direction on the first contact partner and elastically in an opposite direction on the second contact partner. This element is formed with a flange bearing peripherally on the housing around the throughgoing hole.

### CROSS-REFERENCE TO RELATED APPLICATIONS

This application is a division of patent application Ser. No. 10/916,764 filed 11 Aug. 2004 with a claim to the priorities of German applications 103 36 846.9 filed 11 Aug. 2003 and 103 58 120.0 filed 12 Dec. 2003.

### FIELD OF THE INVENTION

The invention relates to a device for making an electrical contact between a first contact partner and at least one further contact partner by way of a contact element.

### BACKGROUND OF THE INVENTION

From DE 196 05 999 A1, the electrical contacting with a flat antenna conductor structure is known. In this case, below a part of the body of the vehicle, a signal processing unit, especially an antenna amplifier, is mounted by suitable fastening means. The housing of: this unit has a carrier (outrigger arm) at whose end contacting means are provided. These contacting means are connected via connecting conductors or lines, which are arranged in or on the rigid carrier, with the signal processing unit. Through the contacting means an electrical contact is made to the contact surfaces of an antenna conductor structure which is disposed on the vehicle window. The carrier permits, on the one hand, to connect the antenna conductor structure with the signal processing unit over a certain distance. Because of the location at which the unit must be built into the vehicle and the location of the contact surfaces of the antenna conductor structure, high tolerances must be bridged by the contacting means for the contact surfaces of the antenna conductor structure are to be met by such contacting means. A further drawback of this construction is that the entire signal processing with the carrier and the contact means disposed on the carrier must be completely replaced when it for example is damaged in a crash of the vehicle. The case of a crash of the motor vehicle is associated with high cost since the signal processing unit as a rule is integrated between the body of the vehicle (vehicle roof) and the ceiling of the vehicle and thus is only accessible with difficulty.

Furthermore there is a drawback in that the rigid support always must be matched to the particular vehicle type with respect to its geometry since each vehicle type has its own location at which the unit can be built in as distinguished from the corresponding locations to all other vehicle types. This machining is associated with high cost since for each carrier for each vehicle type, different tools must be provided for making the carrier.

### OBJECT OF THE INVENTION

It is the object of the invention to provide a device for making electrical contacts between a first contact partner and at least one further contact partner over a contact element which can be mounted simply, which is capable of compensating for tolerances and which in the case of damage is easily replaceable.

### SUMMARY OF THE INVENTION

According to the invention, the contact element is electrically conductive and elastically deformable and so shaped that because of its shape it can be fixed in the housing of the electronic device or a carrier. Because of the electrical conductivity of the contact element, the first contact partner which, for example, is a contact surface of a circuit board, especially a printed circuit board, disposed in the housing, can be electrically connected with at least one further contact partner which is arranged outside the housing of the electronic device. The elastic deformability has the advantage that on the one hand tolerances in all directions and preferably in the mounting direction of the electronic device can be compensated at the point at which the electronic device is built into the vehicle. On the other hand the elastic deformability has the advantage that after mounting of the electronic device at the location at which it is to be built into the vehicle, because of the elastic deformation of the contact element a continuous pressure will be produced by the contact element against the at least two contact partners so that thereby a permanent and effective electrical contact connection is achieved. Furthermore, an important aspect of the contact element according to the invention is its aspect which mainly is so configured that because of its shape the contact element can be fixed in or on the housing of the electronic device. Thus for example in a first embodiment of the invention this shape can have a contraction or pinched portion by means of which the contact element can engage in a corresponding recess in the housing of the electronic device. When in the fabrication of the housing such a recess (or also a plurality of recesses) is provided, the contact element can then be formfittingly inserted in this recess with its contracted portion and fixed in its position. Thus the position of the recess and the corresponding contact surface of the circuit board within the housing can be so positioned mutually that the contact element with its electrically conductive region comes to bear upon the contact surface of the circuit board (first contact partner). Alternatively thereto it is conceivable that the contact element will have a shoulder extending at least partly therearound or shoulder-like segments projecting from the contact element (for example wings) whereby the contact element can be inserted in the recess and which enables connection via the shoulder or shoulder-like segment with the housing. The connection of the shoulder or the shoulder-like segment with the housing can be effected for example by adhesive bonding or by other suitable releasable or nonreleasable connection methods. In this connection it is also conceivable that the shoulder or shoulder segment is electrically conductive or is not electrically conductive. Advantageously the peripheral shoulder or the shoulder segment is electrically nonconductive to provide an insulation of the electrically conductive contact element.

It is also conceivable that the contact element not be inserted into the recess after fabrication of the housing but rather already mounted upon the making of the housing. Thus the prefabricated contact element can be inserted for example in a mold in which the housing is to be made and can be fixed to the housing during its manufacture, for example in an injection-molding process or a plastic. Here as well the contractions, the shoulder extending at least partially around the peripherally or the shoulder-like formation can be advantageous since these configurations enable the contact element to be fixed in the housing of the electronic device.

In a further aspect of the invention, the contact element has at least one recess or a hollow cross section or profile. This has the advantage that the contact element can be simply elastically deformable where it is built in without requiring large forces for the deformation. At the same time this ensures that after mounting of the electronic device at the place in the vehicle at which it is to be installed, the deformation of the contact element will provide a sufficiently high pressing force for the reliable and permanent electrical contacting thereby.

A preferred but not limiting application of the contact system according to the invention is the electrical connection of at least two contact partners by means of the contact element in a motor vehicle in which an electronic device, especially an antenna amplifier, which has a circuit board with corresponding electrical and electronic components, is brought into electrical contact with at least one contact surface on a surface of a vehicle, especially a planar surface (for example a window) with the contact surface forming the further contact partners, of an antenna structure. In this case it is important on the one hand that the electronic device be electrically connected by means of a corresponding number of contact elements with the contact surfaces of the antenna structure (or other contact partners in the vehicle). Using the contact element according to the invention it is possible to make these electrical connections simply, whereby even the fabrication cost for such contact elements can be exceptionally low, thereby having a positive effect on the mass production of such electronic devices. Because of the elastic deformability tolerance compensation is provided, which is in the case of mass production of motor vehicles of importance. A tolerance can thereby be simply bridged. Apart from this is also an advantage that the contact element can be fixed in the housing of the electronic device since such electronic devices as antenna amplifiers, video modules and the like can be fabricated by a supplier to the vehicle manufacturer and installed by the vehicle manufacturer rapidly and in an uncomplicated manner at the location at which it is to be built in. In addition, the contact element of the invention has the advantage that because of its elastic deformability following the mounting in the housing it will not be damaged during storage or transport.

### BRIEF DESCRIPTION OF THE INVENTION

Various configurations of a contact element according to the invention but as to which the invention is not limited, are described in the following and explained in connection with the drawing.

In the drawing:

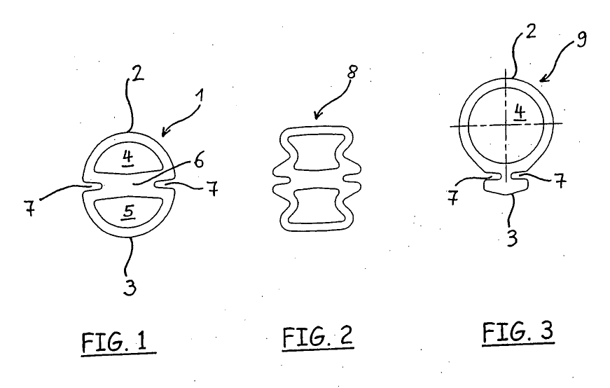

FIGS. 1-3 are elevational views showing different geometric shapes of contact elements with recesses;

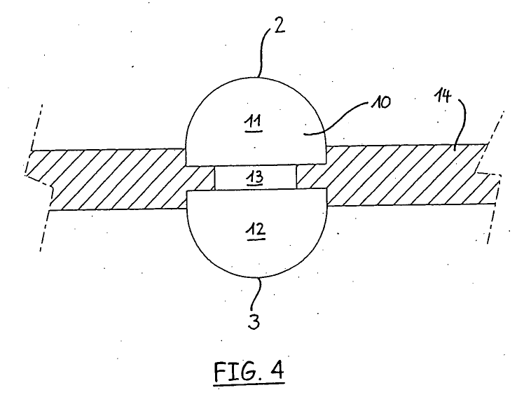

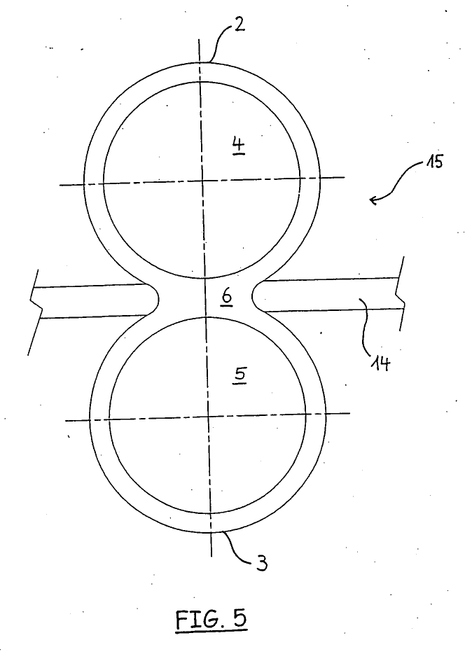

FIG. 4 is a sectional view showing a contact element of solid material;

FIG. 5 is an elevational view of a further embodiment of a contact element with recesses;

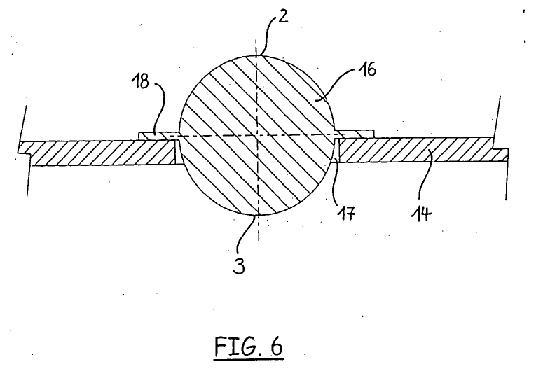

FIG. 6 is a sectional view of a contact element of solid material with a circumferential shoulder; and

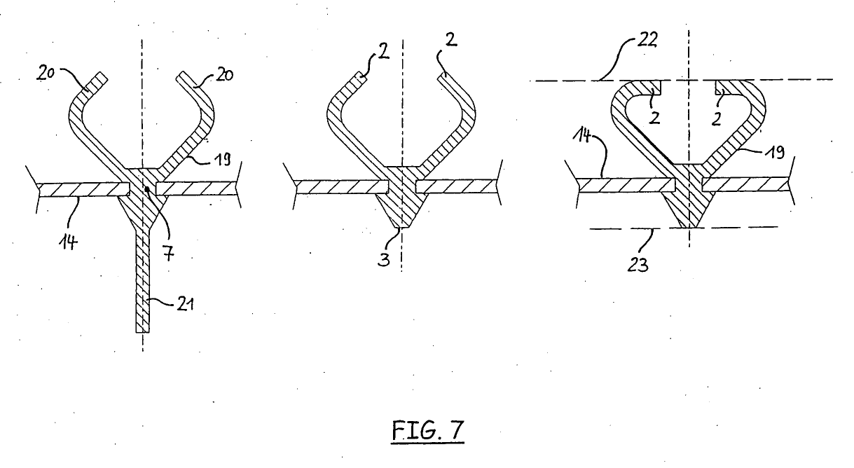

FIG. 7 is a set of sectional views showing the mounting steps for a contact element.

### SPECIFIC DESCRIPTION

FIG. 1 shows a contact element 1 which is comprised of an elastically deformable material. This material is either conductive throughout (for example because of the addition of conductive particles to the base material) or is provided with an electrically conductive layer (here not shown) which can bring about an electrical contact between a first contact partner and at least one further contact partner through this contact element 1. The contact element 1 comes into electrical contact with both of these contact partners with its contact surfaces 2, 3. To improve the elastic deformability, the contact element 1 has two cut outs, hollows or recesses 4, 5 which are so formed that a web 6 lies between them and which is at least partially surrounded and preferably entirely surrounded peripherally or circumferentially by a constriction or contraction 7. Because of this shape, especially with the contraction and the elastic deformability, the contact element can be inserted in an opening in a housing or can be inserted in a mold for the production of the housing to be incorporated in the housing.

FIG. 2 shows another geometric configuration of a contact element 8 which is similar to the contact element 1 of FIG. 2 but has substantially a rectangular configuration or square cross section.

FIG. 3 shows a contact element 9 which also has a contract or constriction 7. In this case the contact element 9 is so formed that it has a recess or cut out 4 in the direction of the contact surface 2 (from the region of the contraction 7) but no recess or cut out in the direction of the contact surface 3, such a shape is preferably used when in the direction of the contact surface 2 large tolerances must be bridged while in the direction of the contact surface 3 only small tolerances need be bridged.

FIG. 4 shows a contact element 10 which has a solid profile (of solid material). Two identical (or mutually different) contact bodies 11, 12 which for example are dome-shaped are comprised of an elastically deformable material and are electrically conductive so that an electrical connection can be formed between two contact surfaces with which the contact element 10 can bear on the corresponding contact partners.

According to FIG. 4 the contact element 10 is also so formed that between two contact bodies 11, 12, a contraction (here shown as a web 13) can be provided with which the contact element 10 can be inserted into a corresponding opening of the housing 14 which is here shown. A contact element shaped in this manner like those described with respect to the preceding Figures and shown therein can, because of its shape, be inserted in a simple manner and way rapidly into the opening of the housing 14. In this case it is also conceivable that one contact element can be inserted into one opening or also that a plurality of contact elements can be inserted into a single opening or also that different contact elements can be inserted into openings.

FIG. 5 shows a further feature in the form of a contact element 15 which generally has the shape and function of the contact element 1 of FIG. 1 but wherein the contact element 15 has a FIG. 8 shape so that the recesses or cut outs 4 and 5 are generally circular but other geometric shapes for the outer and inner contours can however also be conceivable, including for example square or rectangular shapes, trapezoidal shapes, triangular shapes or combinations thereof.

FIG. 6 shows a further configuration of a contact element 16 which does not have a contraction or constriction for fastening the contact element in the housing 14 with its opening or cut out 17 but rather has a shoulder 18 extending partly or completely around it (or alternatively thereto one or more shoulder or shoulder-like segments). The contact element 16 which also has contact surfaces 2, 3 is inserted into at least one opening or cut out 17 and is fixed on or in the housing 14 by the shoulder 18. This attachment can be effected for example by adhesive bonding when the contact element 16 after fabrication of the housing 14 is inserted in the opening or cut out 17. Alternatively thereto it is conceivable to insert the contact element 16 in a mold for producing the housing 14 and then to make the housing (for example by plastic injection molding) so that after formation of the housing the contact element 16 is fixed in place by a material to material bond.

The contraction 7 which is provided around at least part of the periphery, can be uniform therearound or of varied shape and can have identical or different segments.

FIG. 7 shows the steps for mounting a contact element in the housing or carrier. FIG. 7 shows another configuration of the contact element 19 which in one direction has two or more arms 20 and in the other direction has an extension 21. This contact element 19 also has the direction 7 and is composed of an elastically deformable material which is electrically conductive so that the contact element 19 can be anchored by means of its contraction 7 in the housing 14 as has already been described in connection with the preceding Figures. Because of the elastic deformability and the shape of the contact element 19 above and below the contraction 7, it can be provided with an extension 21 beyond the opening in the housing 14 and which can be inserted through that opening whereby to fix the contact element in position, by hand or with a tool, the extension 21 can be grouped and drawn through the opening in the housing 14 until the contraction 7 engages therein. The extension 21 thus serves as an aid in mounting the contact element (left-hand illustration in FIG. 7) which can be then shortened or truncated (as has been shown in the middle illustration in FIG. 7 or can remain in its full length. The right-hand illustration of FIG. 7 shows the contact element 19 after it has been positioned between two contact partners 22 and 23. These contact partners 22 and 23 can be in a preferred application, the contact location or pad of an antenna structure, for example, on a vehicle window, while the opposite contact location can be a part, for example, of an antenna amplifier so that the two contact partners are electrically connected together through the electrically conductive contact element 19. In this case it can be seen that the two ends of the arms 20 form contact surfaces 2 which are deformed and thereby lie flat against the contact partner 22 to make electrical contact therewith. On the opposite side the for example truncated extension 21 in turn forms the contact surface 3 which bears upon the contact partner 23. As a result a tolerance bridge is formed between the contact partners 22 and 23. It is conceivable for the extension 21 not to be foreshortened or to be shortened in such manner that it resists the contact partner 23 upon deformation (for example upon bending). Alternatively, various extensions 21 can bridge different distances between the contact partners 22, 23.

We claim:

1. In combination with a device having a housing holding a first contact partner and with a second contact partner outside the housing, a device for making electrical contact between the first contact partner and second contact partner, the housing being formed adjacent the second contact partner with a throughgoing hole, the device comprising an electrically conductive and elastically deformable contact element engaged with all-around play in the hole between the contact partners and bearing elastically in one direction on the first contact partner and elastically in an opposite direction on the second contact partner, the element being formed with a flange bearing peripherally on the housing around the throughgoing hole.

2. The device defined in claim 1 wherein the body is substantially spherical and the flange is substantially planar.

3. A method of mounting a device for making an electrical contact in a hole of a housing intended to hold a first contact partner, the method comprising the steps of sequentially:
forming an electrically conductive and elastically deformable contact element with a peripheral groove flanked by a pair of shoulders dimensioned to fit snugly in the hole and with to one side of the hole an elongated extension;
inserting the extension through the hole and pulling on the extension such that the body engages the hole and deforms until one of its shoulders passes through the hole and edges of the hole and seat in the groove, with an outside portion of the body and the extension projecting on one side from the housing and an inside portion of the body projecting on the opposite side from the housing; and
cutting off the extension, whereby the outside portion can engage a second contact partner and the inside portion can engage the first contact partner.

4. In combination with a device having a housing holding a first contact partner and with a second contact partner outside the housing, a device for making electrical contact between the first contact partner and second contact partner, the housing being formed adjacent the first contact partner with a throughgoing hole, the device comprising an electrically conductive and elastically deformable contact element having a central groove fitted to edges of the hole and having an outside portion bearing elastically in one direction on the second contact partner, the body being formed to an opposite side of the groove with a pair of inwardly projecting arms elastically engaging the first contact partner.
